(19) United States
(12) Patent Application Publication
(10) Pub. No.: US 2003/0021978 A1
(43) Pub. Date: Jan. 30, 2003

(54) Non-woven fiber mattress composite

(76) Inventor: Anthony Wolf, Fort Wayne, IN (US)

Correspondence Address: RANDALL J. KNUTH P.C., 3510-A STELLHORN ROAD, FORT WAYNE, IN, 46815-4631, US

(21) Appl. No.: 10/207,348

(22) Filed: Jul. 29, 2002

Related U.S. Application Data
(60) Provisional application No. 60/308,728, filed on Jul. 30, 2001.

(51) Int. Cl. B32B 27/04

(52) U.S. Cl. 428/297.4; 428/299.7

(57) ABSTRACT

A non-woven, bonded cotton fiber composite material useful in mattresses, futons, pillows, and upholstery has increased fire resistance and fire suppression properties. The non-woven, fiber composite includes a fibrous polyester material, a fibrous cotton material, and a powdered form of boric acid. The fibrous polyester material, the fibrous cotton material, and the powdered form of boric acid are admixed together to form a composite structure.

### CONTINUATION DATA

The present application hereby claims the benefit under Title 35, United States Code §119(e) of U.S. provisional application No. 60/308,728 filed Jul. 30, 2001.

### BACKGROUND OF THE INVENTION

1. Field of the Invention

The present invention relates generally to mattresses and futons, and more particularly to mattresses and futons made with a particular non-woven fiber cotton composite material utilized as a fire suppression or reduction layer.

2. Description of the Related Art

Prior mattresses and pillows have heretofore been constructed with a cotton batting top layer overdrawn on either foam or insulation layers above a spring coil mattress core.

Prior particular layers of upholstery utilized asbestos carbonate or glass fibric outer layers wrapped around the foam cushions operating as a means for blocking fire or smoldering ignition from penetrating into the inner layers that would be susceptible to fires. Polyester layers can be extremely flammable or extremely flame retardant depending upon on the particular polyester used. Generally the less flame retardant the material the less expensive it is. Prior fire suppression or reduction layers utilized woven fiberglass or the like to prevent fire or smoldering. As understood by the present inventor most insulating-type layers were spun bonded or woven. Prior materials used in such layers utilized boric acid treated cotton as the insulating layer. Boric acid is a known fire suppressant.

### SUMMARY OF THE INVENTION

The present invention is that of an insulating non-woven cotton thermally bonded composite treated with boric acid powder.

The bonded non-woven cotton layer is made in a number of different procedures such as either needle punched or air-laid, as per known technology.

The insulating thermally bonded non-woven cotton layer includes various proportions of thermally activated polymer fibers that, when heated, bond the non-woven cotton fibers together in a matrix with the admixed boric acid powder.

One advantage of the present invention is that of improved fire resistance for use of non-woven materials as the outer covering of mattresses, futons, and pillows.

Another advantage is the ease of handling and manufacture as no spinning or additional weaving is necessary for the composite fiber manufacturing, e.g., via an air-laying or needle punching operation.

Yet another advantage of the present invention is that, by use of the non-woven thermally bonded material with boric acid added thereto such mattresses, futons, and pillows may allow more flexible filling options such as more foam and other various filling types. One particular possibility is the use of layers of approximately two ounces per square foot or less of the new composite.

Still another advantage of the present invention is its use in upholstery products such as seats.

In one form of the present invention, a thermally bonded non-woven cotton fiber composite is formed having particular percentages of boric acid as shown for use in mattresses, pillows, futons, and upholstery products.

### DETAILED DESCRIPTION OF THE INVENTION

The present invention of a non-woven, thermally bonded cotton fiber composite is not heretofore been shown for use in outer cushioning, protective layers of mattresses, cushions, pillows, hospital furniture, automobile upholstery, household upholstery, automobile liners, liners for office cubicles, sub-flooring, and residential or commercial insulation. Traditional composites or materials utilized in such avenues use a cotton batting rather than a non-woven, bonded cotton material.

In the present invention, the composite is formed from three materials. One is a fiber composition of a thermoplastic polyester, in particular, a low melt polyester in the range of 5 to 25 percent by weight (% wt) of the final composite and preferably in the range of 15% wt to 20% wt of the entire composite. A preferred type of polyester binder is a low-melt polyester between 2 to 6 denier, 30 mm to 70 mm in length. The most preferred low-melt polyester has a length of approximately 50 mm. Such low-melt polyesters having increased length increase the resiliency of the final product.

The second component of the composition is that of a clean and possibly combed cotton fiber in the range of 65% wt to 90% wt of the composite.

The third and final element of the composite material is that of a powdered boric acid between 3% wt to 10% wt of the final composite material and advantageously in the range of 5% wt to 10% wt. Such boric acid is useful in increasing the flame retardant and smolder retardant aspects of the composite material.

Of importance is the particular style of or end mixing of the fiber composite materials. The fiber materials advantageously are combined in a so-called intimate blend to maximize the associations and chemical bonds between the various material elements. Such a blend may be described as homogeneous in nature in all three axes of orientation of the product. Advantageously, heat is applied at a level sufficient to achieve bonding between the various material elements. The composite may be formed in a thick or thin layer type structure, essentially having homogeneous properties throughout in all directions (i.e., isotropic).

The present invention with its reduced weight and increased resiliency as compared to prior products is useful and less expensive in forming the outside comfort and/or fire retardant layer in mattress or upholstery products. The mixing technology used may be one of that found in the prior art; however, care must be taken to ensure composite homogenization of the composite materials.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed:

1. A non-woven, fiber composite, comprising:
a fibrous polyester material;
a fibrous cotton material; and
a powdered form of boric acid, said fibrous polyester material, said fibrous cotton material, and said powdered form of boric acid being admixed together to form a composite structure.

2. The non-woven, fiber composite of claim 1, wherein said fibrous polyester material is a low-melt polyester.

3. The non-woven, fiber composite of claim 1, wherein said fibrous polyester material has a length in the range of about 30 mm to about 70 mm.

4. The non-woven, fiber composite of claim 3, wherein said fibrous polyester material has a length of about 50 mm.

5. The non-woven, fiber composite of claim 1, wherein said fibrous polyester material composes about 5 percent by weight (% wt) to about 25% wt of the total composite weight.

6. The non-woven, fiber composite of claim 5, wherein said fibrous polyester material composes about 15% wt to about 20% wt of the total composite weight.

7. The non-woven, fiber composite of claim 1, wherein said fibrous cotton material is composed of cotton fiber that is at least one of cleaned and combed.

8. The non-woven, fiber composite of claim 1, wherein said fibrous cotton material composes about 65 percent by weight (% wt) to about 90% wt of the total composite weight.

9. The non-woven, fiber composite of claim 1, wherein said powdered form of boric acid composes between about 3 percent by weight (% wt) and about 10% wt of the total composite weight.

10. The non-woven, fiber composite of claim 9, wherein said powdered form of boric acid composes at least about 5% wt of the total composite weight.

11. The non-woven, fiber composite of claim 1, wherein said fibrous polyester material, said fibrous cotton material, and said powdered form of boric acid are bonded together, such bonding achieved by an application of heat thereto.

12. The non-woven, fiber composite of claim 1, wherein said fibrous polyester material, said fibrous cotton material, and said powdered form of boric acid are admixed together in a manner so that said composite structure has essentially homogeneous properties throughout.

13. The non-woven, fiber composite of claim 1, wherein said non-woven, fiber composite is both flame retardant and smolder retardant.

14. The non-woven, fiber composite of claim 1, wherein said non-woven, fiber composite forms an outer layer of one of a mattress, cushion, futon, pillow, hospital furniture, automobile upholstery, household upholstery, automobile liner, office-cubicle liner, sub-flooring, and building insulation.
